(19) United States
(12) Patent Application Publication
(10) Pub. No.: US 2004/0155485 A1
(43) Pub. Date: Aug. 12, 2004

(54) Deflector for the air-flow in a motor-vehicle

(76) Inventor: Rudyard Hamnett, Moncalieri (IT)

Correspondence Address: MERCHANT & GOULD PC, P.O. BOX 2903, MINNEAPOLIS, MN, 55402-0903, US

(21) Appl. No.: 10/451,029

(22) PCT Filed: Dec. 10, 2001
(86) PCT No.: PCT/EP01/14456

(30) Foreign Application Priority Data
Dec. 20, 2000 (IT) TO2000U000215

(51) Int. Cl. B62D 35/02

(52) U.S. Cl. 296/180.1

(57) ABSTRACT

A deflector for the air-flow of the rear wheels of motor-vehicles, consisting of a solid body preferably made of plastic material or different material, connectable to the sill of the motor-vehicle ahead of the wheelhouse and presenting the shape of a boat of symmetrical section, with bulwarks of the same height, flat bottom and a flat poop.

The present invention refers to a deflector for the air-flow intended to improve the penetration index of the motor-vehicle. More in particular the invention refers to a device to separate the air-flow located under the body side ahead of the rear wheels. Many types of deflectors for the air-flow are known, the so-called “aerodynamic appendixes”, which are intended to reduce the air vortexes that the motor vehicle in motion creates, so that the aerodynamic resistance is reduced.

In addition to the bodywork it is necessary to take into consideration the resistance created by the front surface of the wheels, and more in particular that of the rear wheels, which are more exposed being the front wheels “protected” by baffles or spoilers located at the front of the motor-vehicle.

It is an object of the present invention to provide a simple and economical device intended to deflect the air-flow from the rear wheels.

Said object is achieved by means of a device that deflects the air-flow from the rear wheels of a motor-vehicle presenting the characteristics of claim 1.

Additional characteristics and advantages will become clear from the following description referring to the appended drawings provided as non-restrictive example, in which:

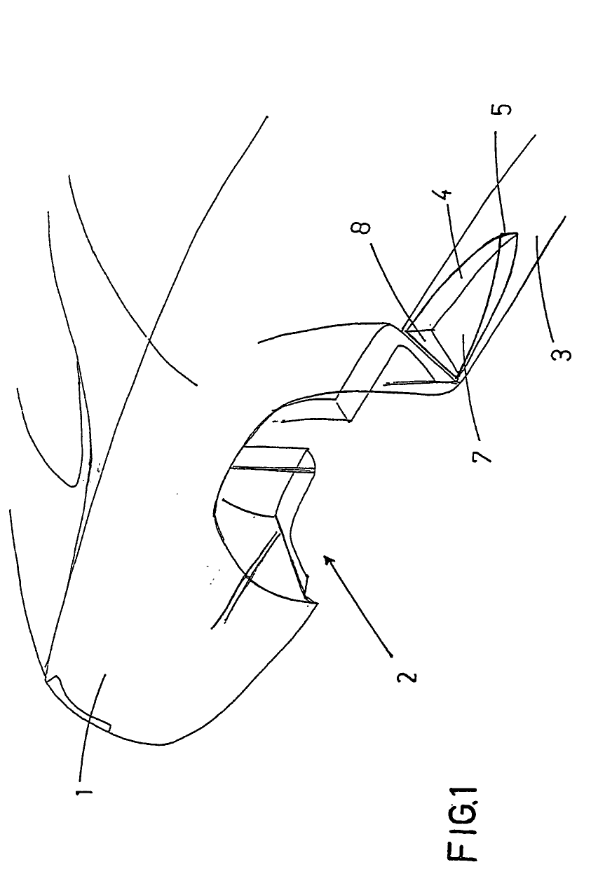

FIG. 1 is a magnified perspective transparent view of the rear part of the body side of a motor vehicle, provided with the air-flow deflector according to the invention;

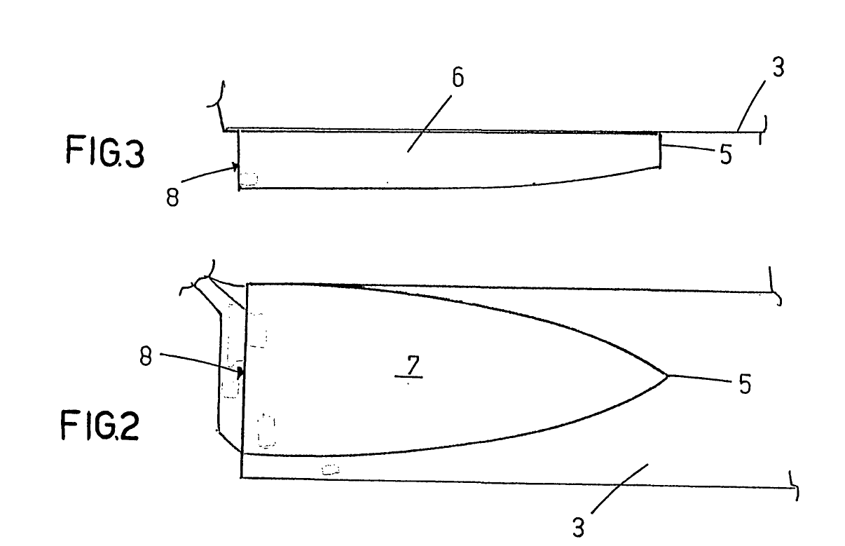

FIG. 2 is a magnified transparent top view of the device in FIG. 1 mounted on part of the sill, and

FIG. 3 is a side view, from inside the motor-vehicle, of the device in FIG. 2.

With reference to the figures, reference number 1 indicates the rear part of the body side of a motor-vehicle, provided with a wheelhouse 2 for the rear wheel (not shown). On the lower part of the body side, between the rear and the front wheelhouse, usually called “sill” 3, there is a deflector 4 for the air-flow.

According to the invention the device consists of a solid body preferably made of plastic material. Its shape is that of a boat, the preferred embodiment being symmetrical, presenting a sharp bow, bulwarks 6 of the same height, flat bottom 7 and a flat poop 8. The optimum width corresponds to the width of the tyre mounted on the motor-vehicle.

As it can be seen in FIG. 1, the device is connected to the sill, in a known way, with the bow 5 towards the front part of the motor-vehicle, the bulwark corresponding to the inside edge of the wheel and the poop 8 corresponding to the opening of the wheelhouse.

The embodiment shown in FIGS. 1 and 3 presents an asymmetrical shape in order to better fit the shape of the motor-vehicle and to be more pleasant from the esthetical point of view, even if part of the effectiveness of the symmetrical shape is lost. It therefore presents a body side that narrows towards the poop and a curved bottom with the bow higher than the central part of the hull. Besides, it is narrower than the width of the tyre and its internal bulwark is located edgewise with the internal edge of said tyre.

It is obvious that the dimensions of the device will be proportional to the dimensions of the motor-vehicle, being the width basically the same as the width of the tyre. Particular attention is to be paid to the pitch, the back angle, the height from the ground at full load and the section of the body side.

The device can be mass forged with an applied—not structural—sill, or can be applied, detachable in the case of a structural sill and/or in case of presence of hooks of the Webb type, couplings to lift the motor-vehicle, holes or elements of any kind that can modify the geometry between the sill and the device itself.

1. A deflector for the air-flow of the rear wheels of motor-vehicles, consisting of a solid body preferably made of plastic material or different material, connectable to the sill of the motor-vehicle ahead of the wheelhouse and characterised in that it presents the shape of a boat of symmetrical section, with bulwarks (6) of the same height, flat bottom (7) and a flat poop (8).

2. An air-flow deflector as claimed in claim 1, characterised in that its width is basically the same as the width of the rear tyres to which it is coupled.

3. An air-flow deflector as claimed in claim 1, characterised in that the shape of the boat is asymmetrical and the bulwarks are of different height.
